(19) United States
(12) Patent Application Publication
(10) Pub. No.: US 2008/0135184 A1
(43) Pub. Date: Jun. 12, 2008

(54) Structure of thermal conductive case in laminator

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,675

(22) Filed: May 7, 2007

(30) Foreign Application Priority Data
Dec. 11, 2006 (TW) 095221779

(51) Int. Cl. B30B 3/00

(52) U.S. Cl. 156/583.1

(57) ABSTRACT

This specification discloses an improved structure of the thermal conductive case in a laminator. It includes two side frames, upper and lower thermal conductive plates integrally formed on the frames, a pressing roller set fixed on the frames and between the upper and lower thermal conductive plates, and heating elements installed between the upper and lower thermal conductive plates. The two sidewalls of the upper thermal conductive plate is formed with several thermally convective through holes and several cavities bent inward for inserting one of the heating elements, positioning it on the inner side of the upper thermal conductive plate. The bottom of the two sidewalls of the lower thermal conductive plate is also shrunk to form a cavity for inserting the other heating element, positioning it on the inner side of the lower thermal conductive plate. When the power is turned on for the heating elements to warm up the pressing rollers, the thermally convective through holes on the two sidewalls of the upper thermal conductive plate enable rapid heat exchange between the inside and outside of the thermal conductive case. This enhances the heat transfer rate, so that the pressing rollers can be rapidly heated to the required working temperature for laminating. Therefore, the user can start operating the laminator within the shortest possible time with ensured quality.

### BACKGROUND OF THE INVENTION

1. Field of Invention

The invention relates to a laminator and, in particular, to an improved structure of the thermal conductive case in a laminator that can speed up its heating time and reach a homogeneous heat distribution.

2. Related Art

As is well known, the laminator is used to protect important documents such as photos and identifications. The laminated product is first inserted into a film. The heating element of the laminator radiates heat to pressing rollers. The film and the laminated product are pressed by the high-temperature pressing rollers and combined together.

In the above-mentioned laminating process, two problems that are complained the most by users are long pre-heating time and inhomogeneous pressing roller temperature. The inhomogeneous pressing roller temperature results in bad laminating quality. A pre-heating time longer than five minutes makes users impatient.

### SUMMARY OF THE INVENTION

An objective of the invention is to provide an improved structure of the thermal conductive case in a laminator that reduces its pre-heating time down to three minutes, so that the user can start operating the laminator within the shortest possible time.

Another objective of the invention is to provide an improved structure of the thermal conductive case in a laminator that provides a homogeneous pressing roller temperature to ensure best laminating quality.

Yet another objective of the invention is to provide an improved structure of the thermal conductive case in a laminator that has an integrally formed cavity for its heating element to be inserted and positioned in the thermal conductive case without the need to use other fixing components such as screws.

To achieve the above-mentioned objectives and to solve the problems in the prior art, the disclosed improved structure of the thermal conductive case in a laminator has several thermally convective through holes formed on the two sidewalls of an upper thermal conductive plate of the thermal conductive case, so that the pressing rollers can be homogeneously heated to the required working temperature. It also has several cavities bent inward for its heating element to be inserted and fixed, without the need of using other fixing components such as screws. The invention can speed up the assembly time of the laminators while reducing the production cost.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the disclosed thermal conductive case of a laminator;

FIG. 2 is a three-dimensional view of the assembled thermal conductive case of a laminator according to the invention; and

FIG. 3 is a cross-sectional view of the disclosed thermal conductive case of a laminator.

### DETAILED DESCRIPTION OF THE INVENTION

The present invention will be apparent from the following detailed description, which proceeds with reference to the accompanying drawings, wherein the same references relate to the same elements.

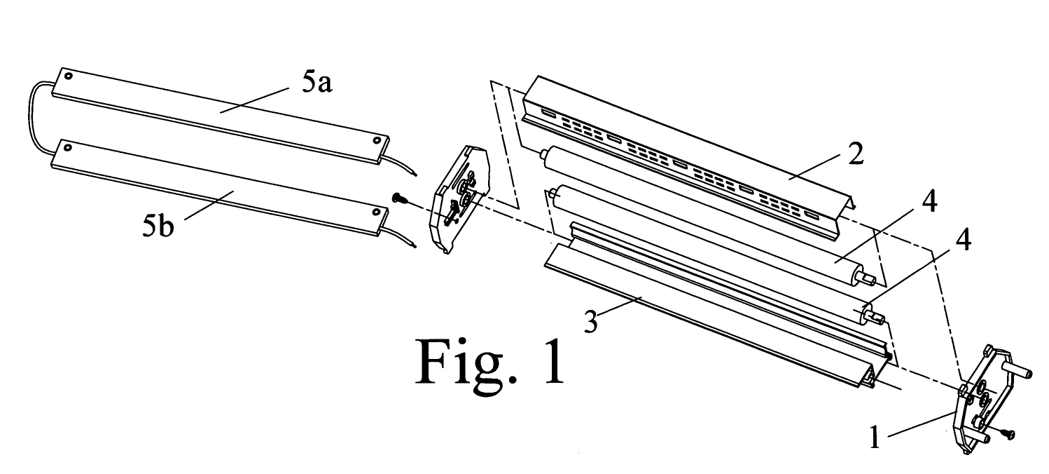

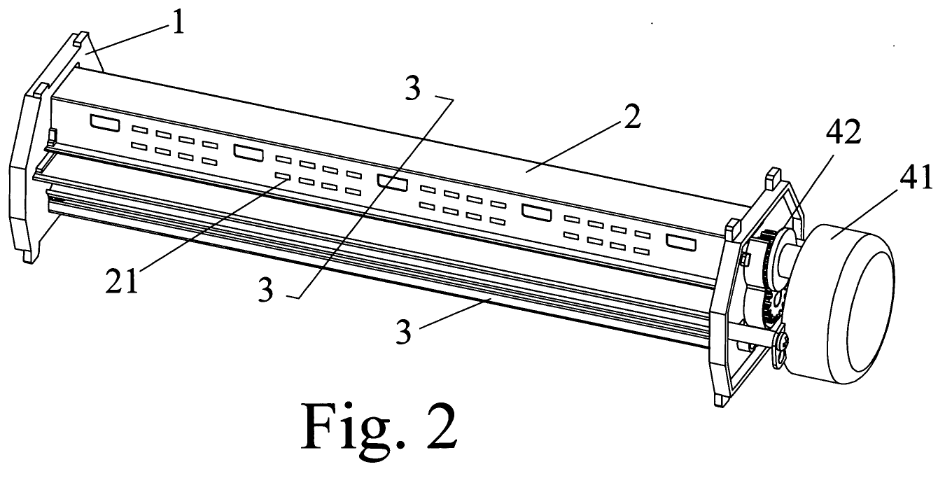

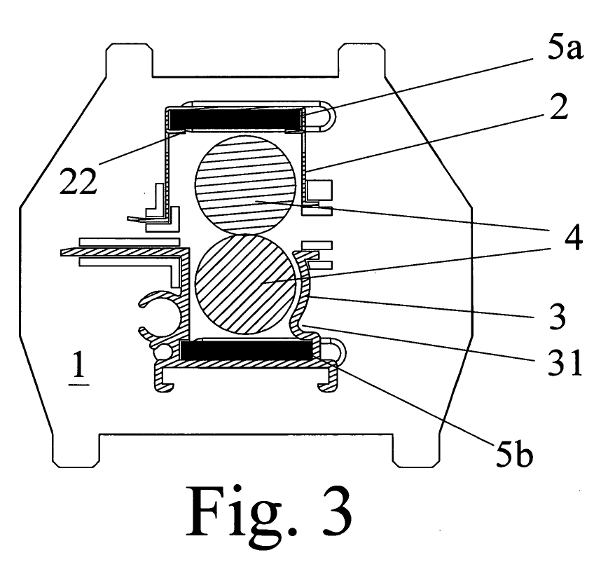

FIG. 1 is a three-dimensional exploded view of the disclosed thermal conductive case of a laminator. FIG. 2 is a three-dimensional view of the assembled thermal conductive case of a laminator according to the invention. FIG. 3 is a cross-sectional view of the disclosed thermal conductive case of a laminator.

As shown in the drawings, the thermal conductive case of a laminator includes two side frames 1, upper and lower thermal conductive plates 2, 3 integrally formed on the frames 1 using aluminum, a pressing roller set 4 fixed on the frames 1 and between the upper and lower thermal conductive plates 2, 3, and heating elements 5a, 5b inserted in the upper and lower thermal conductive plates 2, 3. The pressing rollers in the pressing roller set 4 are driven by a motor 41 via a transmission mechanism 42 to rotate in opposite directions. The two sidewalls of the upper thermal conductive plate 2 are formed with several thermally convective through holes 21 and several cavities 22 bent inward. The cavities 22 allows the insertion of the heating element 5a as shown in FIG. 3, positioning it on the inner side of the upper thermal conductive plate 2. The bottom of the two sidewalls of the lower thermal conductive plate 3 is shrunk to form a cavity 31 for the insertion of the heating element 5b, positioning it on the inner side of the lower thermal conductive plate 3.

When the power is turned on for the heating elements to warm up the pressing rollers, the thermally convective through holes on the two sidewalls of the upper thermal conductive plate enable rapid heat exchange between the inside and outside of the thermal conductive case. This enhances the heat transfer rate, so that the pressing rollers can be rapidly heated to the required working temperature for laminating. Therefore, the user can start operating the laminator within the shortest possible time with ensured quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An improved structure of a thermal conductive case in a laminator, comprising:
two side frames;
upper and lower thermal conductive plates fixed on the frames;
a pressing roller set fixed on the frames and between the upper and lower thermal conductive plates; and
heating elements disposed between the upper and lower thermal conductive plates;
wherein the upper thermal conductive plate is formed with thermally convective holes.

2. The improved structure of a thermal conductive case in a laminator according to claim 1, wherein the thermally convective holes are formed on the two sidewalls of the upper thermal conductive plate.

3. The improved structure of a thermal conductive case in a laminator according to claim 1 or 2, wherein the number of the thermally convective holes is large.
